(19) United States
(12) Patent Application Publication
(10) Pub. No.: US 2008/0178541 A1
(43) Pub. Date: Jul. 31, 2008

(54) Door jamb components, subassemblies, and assemblies

(76) Inventors: Lawrence Frank Kerscher, DePere, WI (US); Gary L. Boldt, Green Bay, WI (US); Todd Noskowiak, Green Bay, WI (US); Todd A. Carlson, DePere, WI (US)

Correspondence Address: WILHELM LAW SERVICE, S.C., 100 W LAWRENCE ST, THIRD FLOOR, APPLETON, WI, 54911, US

(21) Appl. No.: 12/008,639

(22) Filed: Jan. 10, 2008

Related U.S. Application Data
(63) Continuation-in-part of application No. 11/005,725, filed on Dec. 7, 2004.
Application No. 11/005,725 is a continuation of application No. 10/109,759, filed on Mar. 28, 2002, now Pat. No. 7,111,433.
(60) Provisional application No. 60/885,121, filed on Jan. 16, 2007.
(60) Provisional application No. 60/355,592, filed on Feb. 7, 2002.

(51) Int. Cl. E06B 1/34

(52) U.S. Cl. 52/204.1; 52/210; 52/783.12; 52/204.55; 52/741.1

(57) ABSTRACT

Fiber reinforced polymeric pultruded cladding as jamb cover elements and mullion cover elements, for door frames and mullions, using pultruded structures as cladding over substrates. A jamb cover assembly includes a pultruded jamb plate and/or a pultruded nosing, and a mounting fin. The mounting fin extends from a distal side of the assembly. The frame can be secured in a doorway rough opening with the nosing assembled to the jamb plate, using the mounting fin for initial securement, optionally without assembly or disassembly of the frame at the construction site. Pultruded substrate covering covers both the outer surface and opposing sides of a mullion substrate. A pultruded mullion nosing is assembled to the substrate covering, and overlies part of the substrate cover, providing complete pultruded overlayment of the outer surface of the mullion substrate and spacing the front panel of the nosing from the outer surface of the substrate.

### BACKGROUND OF THE INVENTION

This invention pertains specifically to prefabricated and otherwise cladded door frames and mullions, using elongate fiber-reinforced pultruded structures as cladding over frame substrate elements.

As used herein, including in the claims which follow, reference to “entry” door frames is directed to doors which are sized and configured to facilitate ingress and egress of people into and out of a building.

As used herein, including in the claims which follow, reference to “garage” door frames is directed to doors which are sized and configured to facilitate ingress and egress of vehicles into and out of a building.

As used herein, including in the claims which follow, reference to “entrance” door frames is directed generically to all doors which facilitate ingress and egress into and out of a building, and thus includes both personnel entry doors as well as vehicular garage doors.

When installing a door frame into a door opening in a building, it is desirable to have a strong, durable frame which is either prefabricated or easily assembled on the construction site. Preferably, the frame can be assembled at an off-site manufacturing location. In the alternative, it is desirable to have frame elements which are easily assembled at the construction site.

In a typical construction project involving personnel entry doors, door frames and/or mullions are fabricated by a frame and/or mullion fabricator, and shipped to a door assembler. The door assembler receives the frames and/or mullions as fabricated, and assembles e.g. the door slabs and respective frames to each other. The slabs are also commonly purchased separately, from slab manufacturers. The door assembler adds the desired glass inset, if any, to the door slab, assembles the door slab to a selected door frame, and ships the thus assembled door, including frame and slab, to the construction site for installation on the building.

Typically, the basic frame is wood. The door assembler can up-grade the quality and value of the frame, and thus the quality and value of the door assembly, by installing cladding to the left, right, and top frame substrate members, thus to provide exterior surfaces on the frame which have improved toughness and durability, as well as less requirement for maintenance.

In one set of known clad structures, an extruded aluminum profile structure is mounted to the substrate, providing covering on both the side surface of the substrate and over the outer surface of the substrate.

In the alternative, an extruded aluminum jamb plate cover is provided along a side surface of the substrate, but does not extend over the outer surface of the substrate. A separate extruded aluminum nosing grips the jamb plate on a first surface of the substrate, extends across an adjacent surface of the substrate, and grips the opposing surface of the substrate.

In an improvement in versatility of the cladding, over such structures, it is known to provide an extruded aluminum jamb plate which has a main side panel which covers the side surface of the substrate and an outer panel which extends over the adjacent outer surface of the substrate. A nosing, such as in a brick mold profile is mounted to, and extends over, the outer panel of the jamb plate. The outer edge of the outer panel is coincident with the distal side of the nosing. The outer panel of the jamb plate is used to mount the cladding, and thus the door frame, to framing members of the building, by e.g. screws or other fasteners extending through that portion of the outer panel of the jamb plate over which the nosing will be mounted. Accordingly, the nosing cannot be mounted on the jamb plate while the door frame is being mounted to the building.

Such configuration requires that the nosing be assembled to the jamb plate after the door frame is inserted into the rough opening and mounted to the building. By corollary, the nosing can be shipped to the construction site assembled to the jamb plates, whereupon the nosing must be disassembled from the jamb plates before the door frame can be installed on the building, and then the nosing is reassembled to the door frame after the door frame has been installed. While such process provides for shipping of the nosing in an assembled configuration, disassembly at the construction site is required.

In an alternative process, the door frame is shipped to the job site without the nosing assembled to the frame. The nosing is shipped separately, though typically in the same shipment. This process saves the disassembly step at the construction site. However, the separate shipment of the nosing bears a risk of the nosing being mishandled, separated from the door frame, and lost, whereupon the installation job can be completed only by shipping an additional nosing to the job site. Another risk inherent in the above process is that a different style nosing may be shipped in error with the door frame, or that a different style nosing may be shipped in error as a replacement.

In still another known set of extruded aluminum clad structures, the outer panel of the jamb plate extends far enough beyond the distal edge of the nosing that the cladding, and thus the door frame, can be mounted to framing members of the building, by screws or other fasteners extending through that portion of the outer panel of the jamb plate which extends beyond the nosing.

In yet another known set of extruded aluminum clad structures, disclosed in U.S. Pat. No. 7,111,433 Kerscher, a kerf in the nosing receives a mounting fin which extends outwardly beyond the nosing such that the cladding, and thus the door frame can be mounted to framing members of the building, by screws or other fasteners extending through that portion of the outer panel of the jamb plate which extends beyond the nosing.

While aluminum cladding provides certain improvements in toughness and durability over wood, aluminum does not satisfy certain needs. For example, aluminum is a good thermal conductor, and thus can conduct heat outwardly from the building. Aluminum is susceptible to corrosion upon exposure to atmospheric conditions. If aluminum is painted to protect the aluminum from atmospheric conditions, the paint is subject to being damaged, e.g. by physical impacts and other interactions; and there is no known way to repair such paint damage at the building site such that the original appearance is restored.

Thus, there is a need for a better material to be used in cladded door frames, including jamb cover assemblies on respective frame substrates, wherein the better material provides the needed levels of toughness and durability, along with a more maintenance free surface. Such cladding desirably includes a jamb cover assembly which includes a jamb plate and a nosing, and is adapted to receive a mounting fin, and wherein the mounting fin is so positioned with respect to the nosing that the door frame can be mounted and secured in a doorway rough opening of a building while the jamb cover assembly is fully assembled to the respective frame substrates.

There is also a need for such elongate jamb plate wherein an outer panel, which overlies the outer surface of the respective jamb substrate, and which bears mounting structure for receiving a nosing thereon, is devoid of structure, outwardly of the mounting structure, for mounting the jamb plate to a framing member of a building to which the frame is to be mounted.

There is further a need for such nosing for mounting on a jamb plate, wherein a mounting fin kerf is disposed on the nosing proximate a distal side of the nosing.

There is also a need for, in combination, such jamb plate cooperating with a nosing wherein a mounting fin kerf is disposed in a region from proximate a distal side of the nosing to proximate a mounting structure on the jamb plate mounting the nosing and the jamb plate to each other.

There is still further a need for a pre-assembled door frame wherein such jamb cover assembly, comprising a jamb plate and a nosing, is mounted to one or more jamb substrates wherein a mounting fin extends outwardly beyond a distal side of the nosing thereby to enable mounting the jamb cover assembly to a framing member of a building while the nosing is mounted to the jamb plate.

Mullions can be up-graded in much the same manner by adding such improved cladding to mullion substrates.

Accordingly, there is also a need for such cladded mullion assembly wherein a such mullion nosing is mounted to both first and second jamb plates, the jamb plates being mounted on opposing sides of the mullion substrate, and extending over the outer surface of the mullion substrate, and wherein the nosing is mounted to both of the jamb plates proximate the outer surface of the mullion substrate and thus bridges the jamb plates while covering the entire outer surface of the mullion substrate.

There is also a need for a method of installing a door frame in a door opening in a building, including assembling the door frame assembly at an off-site location, transporting the door frame to the building site, and installing the frame in the building, including securing the mounting fin to building framing members while a respective nosing is installed on a respective jamb plate.

### SUMMARY OF THE INVENTION

Fiber reinforced polymeric pultruded cladding is disclosed as jamb cover elements and mullion cover elements, for door frames and mullions, using pultruded structures as the cladding over door jamb substrates and mullion substrates. A jamb cover assembly includes a pultruded jamb plate, a pultruded nosing, and a mounting fin. The mounting fin typically extends from the distal side of the assembly. The door frame can be secured in a doorway rough opening in a building, with the nosing assembled to the jamb plate, and using the mounting fin for the securement, without assembly or disassembly of the frame at the construction site. In the cladded mullion structure, first and second pultruded jamb plates are on opposing sides of a mullion substrate. A pultruded mullion nosing is assembled to the jamb plates, and bridges the jamb plates joining the jamb plates and nosing, providing complete pultruded overlayment of the outer surface of the mullion substrate and spacing the front panel of the nosing from the outer surface of the substrate. In the alternative, a single-piece base plate can cover all of the outer surface of the opposing side surfaces of the mullion substrate.

In a first family of embodiments, the invention comprehends in combination, an elongate fiber-reinforced pultruded polymeric nosing, and an elongate fiber-reinforced pultruded polymeric jamb plate, collectively adapted to be mounted to each other and to a jamb substrate to define at least a portion of a building entrance door frame, the building entrance door frame at least in part defining a building entrance door opening, the elongate pultruded jamb plate having a first length, and comprising a main side panel, and an outer panel extending in a direction which defines an angle transverse to the main side panel and extending away from the main side panel to a distal end; and the elongate pultruded nosing being designed and configured to extend along a substantial portion of the length of the elongate jamb plate, the jamb plate and the nosing collectively comprising mounting structure whereby the jamb plate and the nosing are adapted and configured to be mounted to each other through the mounting structure, which mounting structure communicates with the outer panel of the jamb plate, such that the nosing overlies at least a portion of the outer panel, and wherein the jamb plate and the nosing can be assembled to each other and to the substrate to define at least a portion of the door frame, and the door frame at least in part defines the door opening in the building, and wherein the distal side of the nosing faces away from the door opening.

In some embodiments the nosing has a proximal side and a distal side, the pultruded nosing extending from the proximal side to the distal side as a single-piece unitary structure, the pultruded nosing, when so mounted to the jamb plate, extending in a direction away from the main side panel of the jamb plate and along the outer surface of the substrate, to the distal side of the nosing, the nosing extending beyond the distal end of the outer panel, such that the distal end of the outer panel is disposed between the main side panel and the distal side of the nosing, a mounting fin kerf being defined in one of the jamb plate and the nosing, in a region which extends from proximate the distal side of the nosing to the distal end of the outer panel.

In some embodiments, the nosing and the jamb plate are mounted to each other, the combination further comprising a mounting fin, as a separate and distinct element, in the mounting fin kerf, the mounting fin extending beyond the distal side of the nosing.

In some embodiments, the mounting fin is deflectable, from a mounting position extending generally parallel to the outer panel and into proximity with the jamb substrate when the jamb plate is mounted to the jamb substrate.

In some embodiments, the elongate pultruded jamb plate and the elongate pultruded nosing are finished to fit a first door size, the pultruded jamb plate and the pultruded nosing are collectively adapted and configured to be assembled into a jamb cover assembly which fits the first door size, the elongate pultruded jamb plate has a first length, and comprises a 2-panel jamb plate, the elongate pultruded nosing is designed and configured to extend along a substantial portion of the first length of the jamb plate and consists of a single unitary structure, the elongate pultruded jamb plate and the elongate pultruded nosing are mounted to each other, at least a portion of the mounting structure communicates with the outer panel of the pultruded jamb plate, the combination further comprising a mounting fin kerf in the elongate pultruded nosing, the mounting fin kerf, when the elongate pultruded nosing is mounted to the jamb plate at the outer panel, being located outwardly of the distal end of the outer panel, such that the distal end of the outer panel is disposed generally between the mounting fin kerf and the main side panel, the mounting fin kerf defining an opening configured to receive a mounting fin thereinto.

In some embodiments, the mounting fin kerf is disposed at a distal side of the elongate pultruded nosing, further comprising a mounting fin, the mounting fin being designed and configured to be mounted in the mounting fin kerf.

In some embodiments, the elongate jamb plate, when finished to a first length, and the nosing, when finished to a second length which cooperates with the first length, being collectively adapted and configured to be assembled into a jamb cover assembly. Such jamb cover assembly is adapted and configured to define at least a portion of a door frame, the door frame at least in part defining a door opening through the door frame, the jamb plate and the nosing being adapted and configured to be mounted to each other through the mounting structure such that the elongate pultruded nosing does not overlie the main side panel, the elongate pultruded nosing having a proximal side, and extending as a single unitary structure from the proximal side to a distal side of the elongate pultruded nosing, and wherein, when the elongate pultruded jamb plate and the elongate pultruded nosing are assembled to each other and at least in part define a portion of the door frame, and the door frame at least in part defines a portion of the door opening in the door frame, the distal side of the nosing faces away from the door opening and is disposed beyond the distal end of the outer panel of the jamb plate, such that the distal end of the outer panel is disposed between the distal side of the elongate pultruded nosing and the main side panel of the elongate pultruded jamb plate.

In some embodiments, the nosing and jamb plate comprise fiberglass reinforced pultruded polymeric structures.

In some embodiments the jamb cover assembly combination comprises a combination of an elongate pultruded jamb plate and an elongate pultruded nosing, the jamb plate being finished to a first door size so as to be adapted and configured to interface with the doorway substrate, the outer panel extending from a locus of joinder with the main side panel, the elongate pultruded jamb plate comprising the first mounting structure extending from the outer panel, the nosing comprising a front panel, and the second mounting structure comprising at least first and second legs, the elongate nosing being adapted to mount, by the second mounting structure, to the pultruded jamb plate, the outer panel of the jamb plate, when the jamb plate is mounted in a doorway rough opening in such building, being disposed between at least one of the legs and the substrate, and as a separate and distinct element, a mounting fin adapted to be mounted to the nosing, the mounting fin being deflectable, from a mounting position extending generally parallel to the outer panel, toward the substrate by about 90 degrees or more.

In some embodiments, the nosing does not overlie the main side panel, and the nosing has a proximal side, and extends as a single unitary structure from the proximal side to a distal side of the nosing, and wherein the distal side of the nosing is disposed beyond the distal end of the outer panel of the jamb plate, such that the distal end of the outer panel is disposed between the distal side of the nosing and the main side panel of the jamb plate.

In some embodiments, the jamb plate has a first length, and the jamb substrate has a second length, the first length of the jamb plate generally corresponding to the second length of the jamb substrate, the nosing having a third length generally corresponding to the first length, the pultruded nosing being joined to the pultruded jamb plate, the jamb plate and the jamb substrate defining an elongate frame element subassembly, the frame element subassembly having a first side defined by the pultruded jamb plate and facing across the door opening, a second side defined by the jamb plate and facing in a direction away from the door opening and away from the building when the door frame assembly combination is assembled to the building, a third side facing in an opposite direction from the first side, and a fourth side facing in an opposite direction from the second side, the pultruded nosing having a proximal side, and extending as a single unitary structure from the proximal side to a distal side of the pultruded nosing, the elongate frame element subassembly and the elongate pultruded nosing being mounted to each other through the mounting structure which communicates with only one of the second and fourth sides of the frame element subassembly.

In some embodiments, a mounting fin kerf in the elongate pultruded nosing is located outwardly of the third side of the frame element subassembly, such that the third side of the frame element subassembly is disposed generally between the mounting fin kerf and the first side of the frame element subassembly.

In a second family of embodiments, the invention comprehends a frame assembly combination, adapted and configured to be assembled into a frame assembly, the frame assembly combination comprising an elongate first frame member finished to fit a first size doorway and an elongate fiber reinforced pultruded polymeric nosing finished to fit the first size doorway, the first frame member consisting of a single unitary structure, the first frame member having a main side panel on a first side of the first frame member, and an outer panel on a second side of the first frame member, and extending from a locus of joinder with the main side panel, at an angle transverse to the main side panel, to a distal end of the outer panel, the elongate pultruded nosing having a proximal side and extending, as a single-piece unitary structure from the proximal side to a distal side of the elongate pultruded nosing, the elongate pultruded nosing, when finished to fit the first doorway size, extending along a substantial portion of a first length of the first frame member, the first frame member and the pultruded nosing collectively comprising mounting structure whereby the first frame member and the pultruded nosing are adapted and configured to be mounted to each other through the mounting structure which communicates with the outer panel portion of the first frame member, thereby to assemble a frame assembly, a plurality of the frame assemblies being adapted and configured to be assembled into a door frame which fits the first doorway size, which door frame defines a doorway opening extending through the door frame, further comprising, a mounting fin kerf in the nosing, the mounting fin kerf, when the finished first frame member and the finished nosing are mounted to each other, being located outwardly of the distal end of the outer panel, such that the distal end of the outer panel is disposed generally between the mounting fin kerf and the main side panel.

In some embodiments, the first frame member further comprises a third side, which third side faces away from the doorway opening and in a direction generally opposite the first side, the mounting fin kerf defining an opening configured to receive a mounting fin thereinto, further comprising a mounting fin in the kerf, the first frame member extending along a generally continuous path between the third side and the first side.

In a third family of embodiments, the invention comprehends a door frame assembly comprising an elongate jamb having a first length and an elongate fiber reinforced pultruded polymeric nosing having a second length, and joined to the jamb, the jamb having a main side panel, and an outer panel extending from a locus of joinder with the main side panel, at an angle transverse to the main side panel, to a distal end of the outer panel, the nosing having a proximal side and extending, as a single unitary structure, from the proximal side to a distal side of the nosing, the nosing being mounted to the jamb, further comprising a mounting fin kerf in the nosing, located outwardly of the distal end of the outer panel, such that the distal end of the outer panel is disposed generally between the mounting fin kerf and the main side panel, the kerf defining an opening, configured to receive a mounting fin thereinto, optionally comprising a mounting fin in the kerf, the nosing extending, as a single piece unitary structure, from the proximal side to the distal side, and wherein the nosing comprises a brick mold nosing which is defined, along the second length, by a generally constant cross-section.

In a fourth family of embodiments the invention comprehends a frame assembly, defining at least a portion of a door frame, the door frame defining a door opening through the door frame, the door frame being adapted and configured to be assembled to a building at a doorway rough opening, the frame assembly comprising an elongate frame element having a first length and an elongate fiber reinforced pultruded polymeric nosing having a second length, the pultruded nosing being joined to the frame element, the elongate frame element having a first side adapted to face across the door opening, a second side adapted to face away from the door opening and away from the building, and extending from the first side, to a distal end of the second side, a third side facing away from the door opening, and in an opposite direction from the first side, and a fourth side facing away from the door opening and in an opposite direction from the second side, the pultruded nosing extending as a single unitary structure from a proximal side to a distal side of the nosing, the frame element and the nosing being mounted to each other through mounting structure which communicates with only one of the second and fourth sides of the frame element, further comprising a mounting fin kerf in the nosing, located outwardly of the distal end of the second side of the frame element, such that the distal end of the second side of the frame element is disposed generally between the mounting fin kerf and the first side of the frame element.

In a fifth family of embodiments, the invention comprehends a door frame structure, adapted and configured to define at least a portion of a door frame, the door frame structure comprising an elongate jamb having a first length and an elongate fiber reinforced pultruded polymeric nosing having a second length, and joined to the jamb, the door frame structure, when in an assembly as at least a portion of a door frame, at least in part defining a door opening in the door frame, the jamb comprising a main side panel, and an outer panel extending, from a locus of joinder with the main side panel, at an angle transverse to the main side panel, to a distal end of the outer panel, the nosing being designed and configured to extend along a substantial portion of the first length of the jamb, the jamb and the nosing collectively comprising mounting structure whereby the jamb and the nosing are mounted to each other through such mounting structure which communicates with the outer panel of the jamb, and wherein the pultruded nosing overlies at least a portion of the outer panel and does not overlie the main side panel, the elongate pultruded nosing having a proximal side and extending, as a single unitary structure, from the proximal side to a distal side of the nosing, nosing and jamb being mounted to each other and at least in part defining a portion of the door frame structure, the distal side of the nosing facing away from the door opening in the door frame and being disposed beyond the distal end of the outer panel of the jamb, such that the distal end of the outer panel is disposed between the distal side of the nosing and the main side panel of the jamb.

In a sixth family of embodiments, the invention comprehends an elongate nosing assembly for mounting to an elongate jamb plate, wherein such elongate jamb plate is designed and configured to be mounted on an elongate jamb substrate of a door frame, wherein the elongate jamb plate comprises a main side panel, and at least one outer panel, the at least one outer panel being configured to extend at an angle transverse to the main side panel, and away from the main side panel, a given one the outer panel bearing a first mounting structure having first and second locks, the elongate nosing assembly comprising an elongate fiber reinforced pultruded polymeric nosing comprising second mounting structure having third and fourth locks, designed and configured to cooperatively mount to the first mounting structure of the jamb plate, thereby to mount the nosing to the jamb plate; and an elongate mounting fin mounted to the nosing, and wherein the mounting fin is adapted to be articulated toward the main side panel of the jamb plate, and into proximity with a the jamb substrate when the nosing assembly is mounted to such jamb plate which is mounted to a the jamb substrate, the elongate nosing assembly being a two-component assembly comprising the elongate pultruded nosing, as a single-piece nosing, and the elongate mounting fin.

In some embodiments, the nosing comprises a front panel, the second mounting structure being disposed between the front panel and the outer panel of the jamb plate.

In an seventh family of embodiments, the invention comprehends a mullion cover assembly, comprising a first elongate fiber reinforced pultruded polymeric jamb plate comprising a first main side panel, a first outer panel extending at an angle transverse to the first main side panel, the first outer panel comprising a first mounting structure which defines a first locking locus corresponding to a first lateral location along a first width of the first outer panel; as a separate and distinct element, a second elongate fiber reinforced pultruded polymeric jamb plate comprising a second main side panel, a second outer panel extending at an angle transverse to the second main side panel, the second outer panel comprising a second mounting structure which defines a second locking locus corresponding to a second lateral location along a second width of the second outer panel, the first and second outer panels, when the first and second elongate jamb plates are mounted to first and second side surfaces of a mullion substrate, generally residing in a common plane with respect to each other; and an elongate fiber reinforced pultruded polymeric nosing comprising a third mounting structure which defines third and fourth locking loci corresponding to third and fourth lateral locations along a third width of the elongate pultruded nosing, the third and fourth locking loci on the elongate pultruded nosing being engageable with the first and second locking loci on the first and second elongate pultruded jamb plates thereby to mount the nosing to first and second jamb plates such that the nosing bridges the jamb plates, and locks together the combination of the nosing and the first and second jamb plates, the distance between the third and fourth loci being at least as great as the sum of any extensions of the first and second outer panels, beyond the first and second locking loci, away from the respective first and second main side panels.

In some embodiments, the elongate pultruded nosing comprises a front panel spaced from the outer panels of the first and second elongate pultruded jamb plates.

In some embodiments, the jamb plates and the nosing comprise fiberglass reinforced pultruded structures.

In some embodiments, the pultruded structures have nominal profile thicknesses of about 0.06 inch to about 0.075 inch.

In some embodiments, the first and second outer panels are spaced from each other when the mullion cover assembly is mounted on a mullion substrate, with the elongate pultruded nosing snap-locked to the first and second elongate pultruded jamb plates, thereby to leave a portion of an outer surface of the mullion substrate uncovered, as an uncovered space between the first and second outer panels, and wherein the elongate pultruded nosing bridges the uncovered space thereby to complete the coverage of the outer surface of the mullion substrate.

In an eighth family of embodiments, the invention comprehends a jamb cover assembly comprising an elongate fiber reinforced pultruded polymeric jamb plate having a first length and an elongate fiber reinforced pultruded polymeric nosing having a second length, and joined to the pultruded jamb plate, the jamb plate comprising a two-panel jamb plate having a main side panel, and an outer panel extending from a locus of joinder with the main side panel, at an angle transverse to the main side panel, to a distal edge of the outer panel, the elongate pultruded nosing extending in a straight line path along a substantial portion of the first length of the pultruded jamb plate and consisting of a single unitary structure, the jamb plate and the nosing collectively comprising mounting structure whereby the jamb plate and the nosing are mounted to each other through mounting structure communicating with the outer panel of the jamb plate, further comprising a mounting fin kerf in the pultruded nosing, located outwardly of the distal edge of the outer panel, such that the distal edge of the outer panel is disposed generally between the mounting fin kerf and the main side panel, the kerf defining an opening, facing away from the outer panel, and configured to receive a mounting fin thereinto.

In a ninth family of embodiments, the invention comprehends a method of up-grading an existing door frame, such as an entry door frame or a garage door frame, and wherein a door opening is defined through the door frame, the existing door frame comprising a door jamb having a main jamb surface which faces into the door opening, a first outer jamb surface which faces a first direction away from the door opening, and a second outer jamb surface which faces a second opposing direction away from the door opening, the method comprising installing fiber reinforced pultruded cladding elements over the main jamb surface and one of the outer jamb surfaces, the fiber reinforced pultruded cladding elements which are installed on a given such jamb comprising an elongate fiber reinforced pultruded jamb plate having a first length, and an elongate fiber reinforced pultruded nosing the jamb plate which is installed on a given such jamb having a main side panel, and an outer panel extending from a locus of joinder with the main side panel, at an angle transverse to the main side panel, to a distal end of the outer panel, the pultruded elongate nosing, which is installed on the given jamb plate, comprising a single unitary structure, the plate and the nosing being mounted to each other through mounting structure which communicates with the outer panel of the jamb plate adjacent only one of the first and second outer jamb surfaces, further comprising a mounting fin kerf in the nosing, located outwardly of the distal edge of the outer panel, such that the distal edge of the outer panel is disposed generally between the mounting fin kerf and the main side panel.

In some embodiments, the elongate pultruded nosing comprises a front panel, mounting structure on the nosing being disposed between the front panel of the nosing and the outer panel of the jamb plate.

In a tenth family of embodiments, the invention comprehends, in combination, an elongate nosing assembly, and an elongate fiber reinforced pultruded polymeric jamb plate, the jamb plate comprising a main side panel, and an outer panel extending at an angle transverse to the main side panel, and away from the main side panel, and first mounting structure comprising first and second locks, the first and second locks being connected to and extending away from the outer panel in a common direction; and the elongate nosing assembly comprising an elongate fiber reinforced pultruded polymeric nosing, the pultruded nosing comprising second mounting structure, the second mounting structure being designed and configured to cooperatively mount to the first mounting structure, thereby to mount the elongate pultruded nosing to the elongate pultruded jamb plate, the nosing, when mounted to the jamb plate, extending away from the main side panel, and as a separate and distinct element, a mounting fin adapted to be mounted to the nosing, the mounting fin, when interfacing with a building to mount the mounting fin thereto, extending generally parallel to the outer panel, the mounting fin being deflectable, from a mounting position extending generally parallel to the outer panel, toward the main side panel of the elongate pultruded jamb plate by about 90 degrees or more, the elongate nosing assembly being a two-component assembly comprising the elongate pultruded nosing, as a single-piece nosing, and the mounting fin.

In an eleventh family of embodiments, the invention comprehends a jamb assembly, comprising an elongate jamb adapted and configured to interface with a doorway substrate, and comprising a main side panel, and an outer panel extending from a locus of joinder with the main side panel to a distal end of the outer panel, the elongate jamb comprising first mounting structure extending from the outer panel; and an elongate nosing assembly comprising an elongate fiber reinforced pultruded polymeric nosing, the pultruded nosing comprising a front panel, and second mounting structure, comprising at least first and second legs, mounting the nosing to the jamb, the outer panel, when the jamb is mounted in a doorway rough opening in a building, being disposed between at least one of the legs and an element of the jamb underlying the outer panel; and as a separate and distinct element, a mounting fin mounted to the elongate pultruded nosing, the mounting fin being deflectable, from a mounting position extending generally parallel to the outer panel, toward the main side panel of the jamb, by about 90 degrees or more, the elongate nosing assembly being a 2-component assembly comprising the nosing as a single-piece nosing, and the mounting fin.

In a twelfth family of embodiments, the invention comprehends a jamb cover assembly, adapted and configured to be mounted to a substrate in a doorway of a building, the substrate generally having a main surface facing across the doorway, and a first outer surface facing away from the building, the jamb cover assembly comprising an elongate fiber reinforced pultruded polymeric jamb plate, comprising a main side panel, a first outer panel extending from a locus of joinder with the main side panel, and first mounting structure, comprising first and second locks on the first outer panel, the first and second locks being proximate a common face of the substrate; and a nosing assembly comprising an elongate fiber reinforced pultruded polymeric nosing comprising second mounting structure, cooperatively mounting to the first mounting structure, thereby mounting the nosing to the jamb plate, and as a separate and distinct element, a mounting fin adapted to be mounted to the nosing, the mounting fin being deflectable toward the main side panel of the pultruded jamb plate by about 90 degrees or more, the elongate nosing assembly being a 2-component assembly comprising the elongate pultruded nosing, as a single-piece nosing, and the mounting fin.

In a thirteenth family of embodiments, the invention comprehends a jamb cover assembly comprising an elongate fiber reinforced pultruded polymeric jamb plate having a first length and an elongate fiber reinforced pultruded polymeric nosing having a second length, and joined to the pultruded jamb plate, the jamb plate consisting of a single unitary structure, jamb plate having a main side panel portion, and an outer panel portion extending from a locus of joinder with the main side panel portion, at an angle transverse to the main side panel portion, to a distal edge of the outer panel portion, the nosing extending in a straight line path along a substantial portion of the first length of the jamb plate and consisting of a single unitary structure, the jamb plate and nosing collectively comprising mounting structure whereby the jamb plate and the nosing are mounted to each other through mounting structure communicating with the outer panel portion of the jamb plate, further comprising a mounting fin kerf in nosing, located outwardly of the distal edge of the outer panel, such that the distal edge of the outer panel is disposed generally between the mounting fin kerf and the main side panel, the mounting fin kerf defining an opening, facing away from the outer panel, the opening being configured to receive a mounting fin thereinto.

In a fourteenth family of embodiments, the invention comprehends a nosing assembly combination comprising a fiber reinforced pultruded polymeric nosing finished to fit a first door size, and a mounting fin, adapted and configured to be assembled to each other, thereby to form an elongate nosing assembly, the nosing assembly being designed and configured to be mounted to an elongate jamb plate corresponding to the first door size, wherein the elongate jamb plate is designed and configured to be mounted on an elongate jamb substrate of a door frame, wherein the elongate jamb plate comprises a main side panel, and at least one outer panel, such at least one outer panel being configured to extend at an angle transverse to the main side panel, and away from the main side panel, a given one such outer panel bearing a first mounting structure having first and second locks, said elongate fiber reinforced pultruded polymeric nosing comprising second mounting structure having third and fourth locks, designed and configured to cooperatively mount to the first mounting structure of the jamb plate, thereby to mount the elongate pultruded nosing to the jamb plate; and the mounting fin being designed and configured to be mounted to the elongate pultruded nosing, and wherein the mounting fin, when mounted to the pultruded nosing, is adapted to be articulated toward the main side panel of the jamb plate, to a substantial degree when the nosing, with the mounting fin mounted thereto, is mounted to such jamb plate, the nosing having a proximal side and extending, as a single-piece unitary structure, from the proximal side to a distal side of the elongate pultruded nosing.

In a fifteenth family of embodiments, the invention comprehends an elongate nosing assembly for use as part of a door frame, wherein the door frame comprises a frame member, the frame member having a first side panel, and a second outer panel, the second outer panel being configured to extend at an angle transverse to the first side panel, and away from the first side panel, the outer panel bearing a first mounting structure having first and second locks, the nosing assembly comprising an elongate fiber reinforced pultruded polymeric nosing comprising second mounting structure having third and fourth locks designed and configured to cooperatively mount to the first mounting structure of the frame member, thereby to mount the elongate pultruded nosing to the frame member; and a mounting fin mounted to the pultruded nosing, and wherein the mounting fin is adapted to be articulated toward the first side panel of the frame member, and into proximity with the frame member when the elongate nosing assembly is mounted to the frame member, the nosing having a proximal side and extending, as a single-piece unitary structure from the proximal side to a distal side of the elongate pultruded nosing.

### BRIEF DESCRIPTION OF THE DRAWINGS

FIG. 1 shows a front elevation view of a door frame of the invention.

FIG. 2 shows an enlarged cross-section of the door frame of FIG. 1, taken at 2-2 of FIG. 1.

FIG. 3 shows a fragmentary end view of an elongate jamb cover assembly of the invention having a medium-width nosing, and mounted on a door jamb.

FIG. 4 shows a fragmentary end view of an elongate jamb cover assembly of the invention having a brick-mold nosing, and mounted on a door jamb.

FIG. 5 shows an end view of a mullion substrate covered on opposing side surfaces by first and second elongate fiber reinforced pultruded polymeric jamb plates of the invention, and an elongate fiber-reinforced pultruded polymeric mullion nosing cover of the invention mounted to the pultruded jamb plates and bridging the jamb plates, thereby to provide a unitary appearance to the face of the mullion while protecting the mullion from the outside environment.

FIG. 6 shows an end view of a mullion substrate, covered on opposing sides, and on the outer surface by a single-piece substrate cover.

The invention is not limited in its application to the details of construction, or to the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

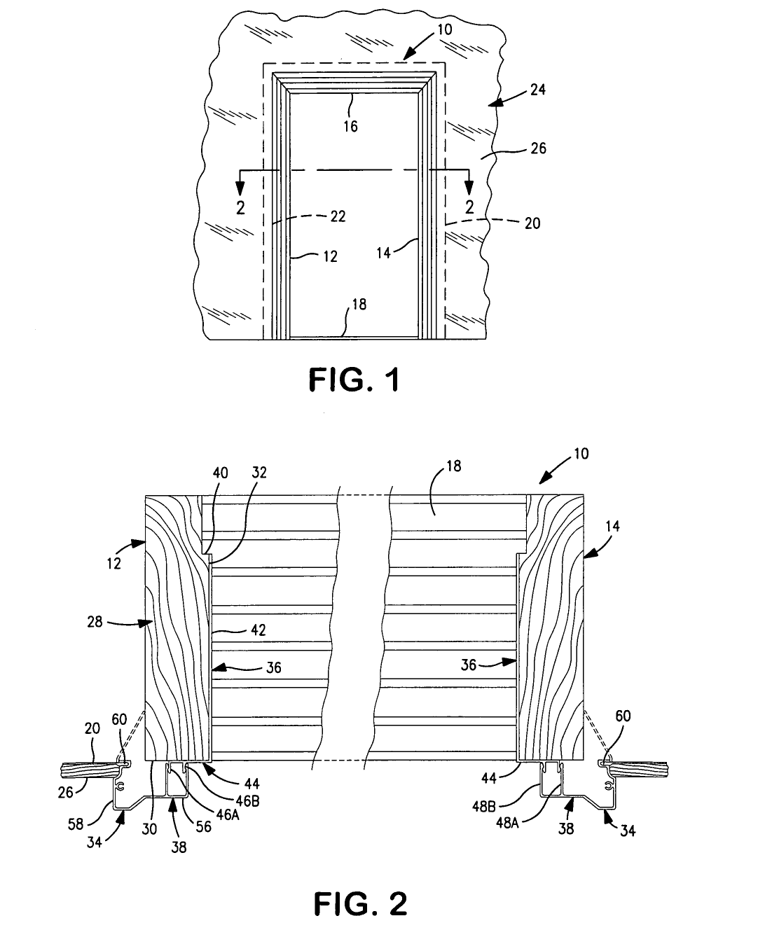

Referring now to the drawings, FIGS. 1 and 2 show a pre-assembled door frame 10 of the invention, The door frame includes a left frame element 12, a right frame element 14, a top frame element 16, and a sill 18, as well as a mounting fin 20 mounted to each of the left, right, and top frame elements. The door frame as shown in FIG. 1 has been inserted into a doorway rough opening 22 in a building 24. As illustrated in FIGS. 1 and 2, a layer of sheet material 26 such as sheathing or siding has been installed over the mounting fin.

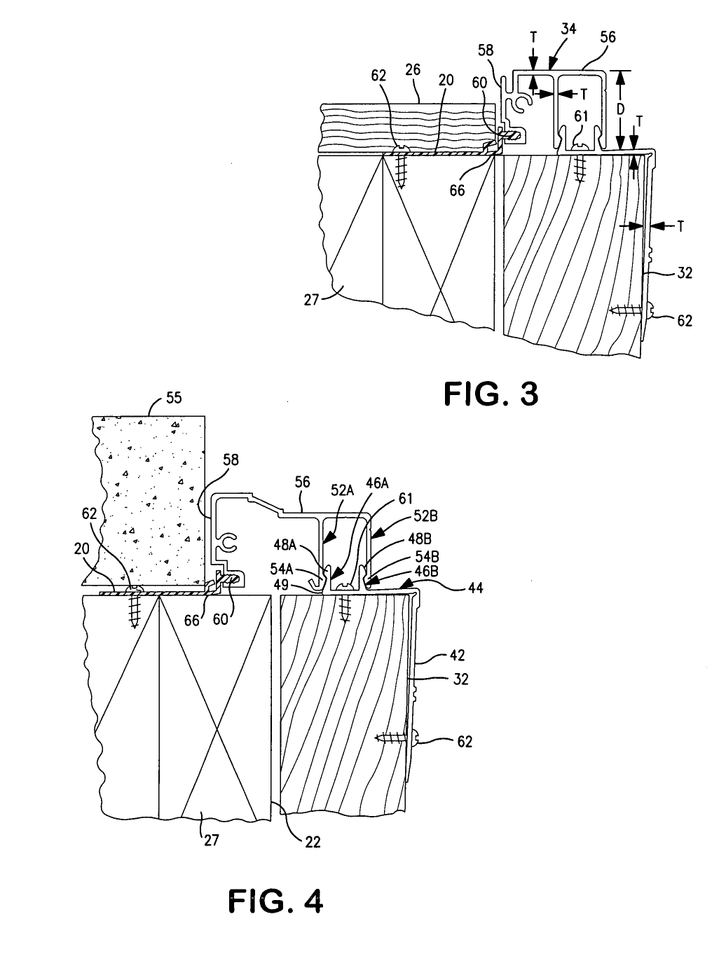

Referring to FIG. 2, the left, right, and top frame elements all have substantially the same structure, so only one will be described. Framing members 27 of the building are not shown in FIG. 2 in order to focus attention on the jamb cover assemblies of the invention. Those skilled in the art will know the typical dimensions of door framing members, and the typical locations and standard dimensions of the building framing members, which are shown in FIGS. 3 and 4. Referring to the left frame element in FIG. 2, an elongate wood jamb substrate element 28 extends the full length of the left frame element and serves as a substrate for the left frame element. Substrate 28 has a length of typical standard dimension, an outer surface 30 providing a building interface facing outwardly away from the building, an opposing outer surface 30A (FIG. 2) facing inwardly into the building, and a side surface 32 facing across the framed door opening 22 in the building.

A jamb cover assembly 34 is mounted to the elongate wood substrate. The jamb cover assembly includes an elongate fiber reinforced pultruded polymeric jamb plate 36, an elongate fiber reinforced pultruded polymeric nosing 38, and a respective elongate mounting fin 20, also known as a nailing fin. Elongate pultruded jamb plate 36 includes a main side panel 42 covering at least a major portion of the side surface 32 of the substrate, along at least a major portion of the length of the substrate. In preferred embodiments, as in FIGS. 1 and 2, the main side panel covers substantially the entirety of the substrate side surface from the outer surface 30 of the substrate to the door seat 40.

Pultruded jamb plate 36 further includes an outer panel 44 covering at least a substantial portion, optionally a major portion, of the outer surface 30 of the substrate, along at least a major portion of the length of the substrate. In preferred embodiments, as in FIGS. 1 and 2, the outer panel extends along substantially the entire length of the substrate outer surface. As seen in FIG. 2, the outer surface of the pultruded jamb plate is attached to main side panel 42 and extends at a perpendicular, or nearly perpendicular, angle transverse to the main side panel, and extends away from the main side panel and over the outer surface of the jamb substrate. Typically, the included angle between main side panel 42 and outer panel 44 is about 87 degrees. In the embodiment illustrated, the outer panel of the jamb plate is in general surface-to-surface relationship, optionally surface-to-surface contact, with the outer surface of the substrate.

Referring more particularly to FIGS. 3 and 4, the outer panel further includes first mounting structure in the form of first and second studs 46A and 46B which have snap locks 48A and 48B, as locking loci, proximate the ends of the respective studs and proximate outer jamb surface 30 and not proximate outer jamb surface 30A. As illustrated in FIGS. 3 and 4, cross-sections of studs 46A and 46B can be substantial mirror images of each other. Outer panel 44 extends to a distal edge 49 proximate the outermost leg 46A.

Nosing 38 is shown in FIGS. 2 and 4 has a cross-sectional outline commonly recognized as a “brick mold” in the building trades. Nosing 38 includes second mounting structure in the form of first and second legs 52A and 52B which extend in a common direction toward the first mounting structure, and which accordingly have snap locks 54A, 54B on the respective legs, cooperating with snap locks 48A and 48B to mount the nosing 38 and outer panel 44 of jamb plate 36 to each other.

Legs 52A and 52B extend outwardly from studs 46A and 46B and away from the building and are connected at spaced locations of the legs to a front panel 56 of the nosing. Front panel 56 extends transversely of the jamb plate main side panel, and follows a direction generally corresponding to the direction of extension of outer panel 44 of the jamb plate. Front panel 56 is typically displaced from the outer surface of the substrate, and thus from the outer panel of the jamb plate, by a distance corresponding to a typical depth of the nosing. Accordingly, while spacing between the outer surface of the substrate and the front panel of the nosing can, in some instances, be a nominal distance, the typical application of the nosing is directed toward replacing the typical e.g. brick mold type trim, or other known trim profile, around a door frame. Thus, typical distances between the outer surface of the substrate and the outer surface of the front panel of the nosing are about 0.5 inch to about 1.5 inches, preferably about 0.6 inch to about 1.25 inches, even more preferably about 1 inch to about 1.13 inches.

As illustrated in FIGS. 2-4, front panel 56 can, and typically does, deviate to an extent from a true reproduction of the direction of extension of the front panel of the jamb plate, and thus can define a non-planar surface profile, or an interrupted planar surface profile, or a partially planar surface profile, of the nosing which nonetheless extends generally along, and displaced from, the outer surface of the outer panel of the jamb plate. FIG. 3 shows a profile generally corresponding with commonly known window trim profiles. FIG. 4 shows the profile generally known as a brick mold profile, and shows a brick 55 representatively located adjacent the brick mold.

As seen in FIGS. 2-4, front panel 56 extends away from legs 52A and 52B, away from main side panel 42 of the pultruded jamb plate, to a distal side 58 of the pultruded nosing. A mounting fin kerf 60 is built into either the pultruded jamb plate or the pultruded nosing. In general, the mounting fin kerf can be located in a region which extends from proximate the distal side of the pultruded nosing to proximate studs 46A and 46B of the outer panel of the pultruded jamb plate. In FIGS. 2-4, the mounting fin kerf is located at distal side 58 of the pultruded nosing, mounting fin 20 being mounted in kerf 60. In the embodiments illustrated in FIGS. 2-4, mounting fin kerf 60 is located at the distal side of the pultruded nosing, whereby mounting fin 20 extends outwardly from the distal side of the combination of the pultruded nosing and the pultruded jamb plate. In the embodiments shown, the mounting fin kerf is built into the distal side of the pultruded nosing. The mounting fin kerf can be located inwardly of the distal side of the pultruded nosing, more toward leg 52A. Typically, the outer panel of the pultruded jamb plate, and thus the entire pultruded jamb plate, is devoid of any mounting fin kerf. However, in some embodiments, the mounting fin kerf can be an element of the outer panel of the pultruded jamb plate, generally proximate outer stud 46A. Wherever the mounting fin kerf, the mounting fin, itself, must extend outwardly of the side edge of the pultruded nosing so that the mounting fin can be secured to framing members of the building, thereby securing the frame to the building, while the pultruded nosing is assembled to the outer panel of the pultruded jamb plate.

A wide variety of mounting structures are contemplated for joining pultruded jamb plate 36 and pultruded nosing 38 to each other as a two-component jamb cover assembly, with optional addition of the mounting fin to the two-component jamb cover assembly, whereby locks 48A, 48B, 54A, 54B are merely exemplary of such mounting structures.

While two elongate pultruded nosing structure profiles are illustrated in FIGS. 2-4, the pultruded nosing profiles illustrated are merely exemplary of a wide variety of nosing profile structures which can be employed in the invention.

As illustrated in FIGS. 3 and 4, primary attachment of jamb cover assembly 34 to the jamb substrate is by screws 61 which are driven through outer panel 44 at spaced locations along the length of jamb plate 36. Jamb cover assembly can also be secured to the jamb substrate at other locations such as by screws or other fasteners 62 at main side panel 42. The pultruded nosing is mounted to the pultruded jamb plate by the mounting structures represented by locks 48A, 48B, 54A, 54B. Pultruded nosing 38 is in turn secured to a building frame member 27 by screws, nails or like fasteners 62 through mounting fin 20.

By providing the elongate pultruded jamb plate, the elongate pultruded nosing, and the elongate mounting fin as separate and distinct jamb cover elements, as illustrated especially in FIGS. 3 and 4, a wide variety of framing needs can be satisfied with a limited inventory of such cover elements.

Whereas prior art jamb cover assemblies require securing the mounting fin to the building framing member under the nosing, which requires that the nosing be assembled to the jamb plate after field installation of the frame in the rough opening at the building site; by positioning the mounting fin such that the mounting fin extends outwardly from the distal side of the jamb cover assembly in the invention, the jamb cover assembly members, including the pultruded nosing, can all be mounted, directly or indirectly, to the frame substrate elements of the door frame assembly, in an off-site manufacturing facility, whereby no frame assembly need be accomplished at the building site.

Accordingly, the door frame can be shipped to the building site fully assembled. The elongate pultruded nosing need not be shipped separately, thereby obviating any risk of losing the pultruded nosing in transit, or forgetting to put the pultruded nosing on the truck with the door frame. Accordingly, the elongate pultruded nosing need not be assembled to the frame at the building site.

Jamb plate 36 and nosing 38 are fiber reinforced pultruded polymeric structures, such as fiberglass reinforced pultrusions wherein the respective profile elements of the pultruded structures have profile thicknesses “T” of about 0.05 inch to about 0.075 inch, with typical thicknesses of about 0.06 inch, optionally 0.062 inch.

As illustrated in FIGS. 2-4, the mounting fin includes a hinge 66 which facilitates articulating or deflecting the mounting fin from its mounting position, wherein the mounting fin extends transverse to and away from both legs 46 and parallel to the outer panel (FIGS. 3-4), toward the main side panel of the pultruded jamb plate and/or substrate element 28 by about 90 degrees or more, illustrated in dashed outline in FIG. 2, e.g. for shipping the door frame, and erecting the mounting fin as illustrated in solid outline in FIG. 2 for attaching the door frame to a building.

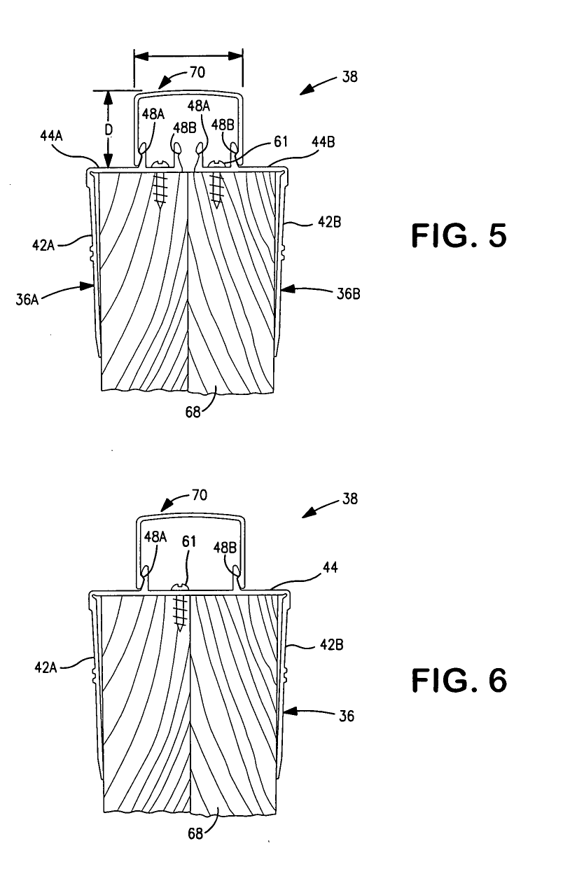

FIG. 5 shows the principles of the jamb cover assembly, including first and second separate and distinct elongate fiber reinforced pultruded polymeric jamb plates 36A and 36B as substrate coverings, and an elongate fiber reinforced pultruded polymeric nosing 70, applied to a mullion substrate 68 adjacent a door opening, as a mullion cover assembly. Such mullion cover assembly can be used, for example, with the combination of a door frame and a side light, or between glass panes in a window or window cluster, or between adjacent doorway openings. As shown in FIG. 5, first and second pultruded polymeric jamb plates 36A, 36B, as used in the previous embodiments as part of a door frame, have respective first and second main side panels and first and second outer panels. First locking loci 48A, 48B are defined on e.g. the outer panel of the left pultruded jamb plate; and second locking loci 48A, 48B are defined on e.g. the outer panel of the right pultruded jamb plate. Third and fourth locking loci are defined on the legs of pultruded mullion nosing 70, which legs correspond to legs 52A, 52B of nosing 38 which is illustrated in FIG. 2. The first and second jamb plates are positioned on opposing side surfaces of the mullion substrate, and are secured to the mullion substrate using e.g. screws 61 as primary securement to the substrate through outer panels 44A, 44B, with optional secondary securement to the substrate through main side panels 42A, 42B using e.g. screws 62 as illustrated in FIGS. 3 and 4. The main side surfaces of substrate cover 36 cover respective side surfaces of the mullion substrate.

Outer panels 44A, 44B of the respective pultruded jamb plates generally reside in a common plane with respect to each other as shown, and partially cover the outer surface of the mullion substrate 68, optionally leaving a portion of the mullion substrate uncovered as shown in FIG. 5. A fiber reinforced pultruded polymeric mullion nosing 70 bridges the jamb plates, and third and fourth locking loci on the nosing snap lock to respective first and second locking loci 48A, 48B on the jamb plates, thereby locking together the combination of the pultruded mullion nosing and the two pultruded jamb plates.

The pultruded mullion nosing extends outwardly from the outer panels and locking studs of the pultruded jamb plates, preferably a distance “D” consistent with the distance “D” on the pultruded nosings of corresponding door jamb cover assemblies, such that the distance “D” of extension of the nosing from the jamb plates, at the mullion cover, is the same magnitude distance “D” of extension of the nosings from the jamb plates at the door frames, whereby the nosings will present a common depth appearance about the entirety of the door area.

FIG. 6 shows a covered mullion as in FIG. 5, using a single-piece fiber-reinforced pultruded polymeric substrate cover 36 to cover the outer surface of substrate 68 as well as both side surfaces of the substrate. Such single-piece pultruded covering is secured to the mullion substrate using e.g. screws 61 as primary securement through outer panel 44, with optional secondary securement through main side panels 42A, 42B using screws 62. First locking loci 48A, 48B are defined on outer panel 44 of substrate covering 36. Cooperating locking legs on nosing 70 correspond to legs 52A, 52B on nosing 38 in FIG. 2. Outer panel 44 extends across the entirety of the width of substrate 68. Pultruded nosing 70 bridges between legs 48A, 48B, on substrate cover 36, and the locking loci on the nosing legs lock to the respective locking loci 48A, 48B on substrate cover 36.

Pultruded mullion nosing 70 is merely a further illustration of the wide variety of nosing structures which can be attached to pultruded jamb plates 36. The width “W” of the pultruded mullion nosing can be selected according to the width of the mullion substrate to which the mullion cover assembly is to be assembled, in combination with the dimensions of the jamb plates with which the pultruded mullion nosing is to be used. The width “W”, of any of the pultruded nosings 38 used in jamb cover assemblies 34, can be selected based on a variety of considerations including, without limitation, aesthetic appeal, and availability of a building framing member to receive mounting fin 20 beyond the distal side of the nosing.

The pultruded jamb assemblies and pultruded mullion cover assemblies of this invention are well suited to provide protective covering for e.g. wood, plastic, or other substrates useful in fabricating door frames, mullions, and the like. Thus, in typical application, the frame or mullion is fabricated by a frame or mullion fabricator, and shipped to a door assembler. The door assembler receives the frame as fabricated, and assembles the frames to door slabs, which typically are also purchased separately. The door assembler adds the desired glass inset, if any, to the door slab, as needed, and assembles the door slab to a selected door frame. Typically, the basic frame is wood.

The door assembler can easily up-grade the quality and value of the door and frame by installing jamb cover elements and/or jamb cover assemblies of the invention to the left, right, and top frame substrate members, thus to provide a tougher, more durable, more maintenance free exterior surface to the frame. Mullions can be up-graded in the same manner. The thus up-graded frame and/or mullion is shipped to the builder at the building site. The builder installs the frame, with or without the door slab, in the respective doorway rough opening in the building. If the door slab is not installed with the frame, the door slab can be installed later.

By designing and configuring the jamb cover assemblies of the invention with the mounting fin extending outwardly from the nosing, the on-site installation to the building can be done without removing the nosing from the jamb cover assembly. By corollary, the jamb cover assembly can be installed on the building without the need to install the nosing to the jamb plate at the building site. Since all such assembly can be accomplished at the off-site manufacturing facility, relatively tighter tolerances can be used, assembly errors can be better controlled, and assembly damage can be better controlled or reduced, as compared to on-site assembly operations. Thus, where cover assemblies of the invention are used in constructing new buildings, the invention provides improved quality control to the process of installing door frames and mullions in the buildings.

Overall, the cover assemblies of the invention produce frames which are known as “cladded” products. Namely, conventional frame materials are “cladded” with the cover assemblies of the invention in order to up-grade the value of the resulting product.

In an alternative use of jamb cover assemblies and mullion cover assemblies of the invention, in new construction, the cover assemblies are installed to the jamb substrates or the mullion substrates at the building site. Such on-site installation can be used e.g. where no local door assembler provides the cladding service.

In addition, such on-site installation of the cladding elements can be used in the after-market to up-grade an existing building, or an existing door frame and/or mullion in an existing building. In such case, the cladding elements, namely the jamb plates and nosings, are installed on the jamb and/or mullion at the building site as add-on components of the respective frame or mullion. In the instance of the existing building, use of the mounting fin is obviated. Where cover assemblies of the invention are used in after-market applications, proper assembly of the jamb cover assembly can be assured, and confirmed, before the jamb cover elements are shipped to the building site.

It should be noted that, while the above embodiments, such as at FIG. 1, have suggested use of the invention with personnel doors, the invention can be used with doors of practically any size. Thus, the inventor contemplates use of the invention on, for example and without limitation, garage doors, doors at truck shipping docks, double personnel doors, and others.

As referred to herein, pultrusion, pultruded structures, and the like, refers to products and processes as commonly recognized in the industry. Thus, a pultruded product or structure or process includes reinforcing fibers embedded in a generally saturating amount of a curable and/or cured or thermoplastic resin, and is included in the general class of materials known as fiber reinforced polymeric structures. Pultrusion is a process which can be used to make continuous lengths of fiber reinforced polymeric products. The starting materials are liquid polymeric resins and fiber structures which reinforce the polymeric resins. As a general statement, the fibrous reinforcing structure is pulled, in a continuous process, through a forming die. In the process, the fibrous structure is impregnated with the polymeric resin, the overall structure is formed into a desired profile, and the resin/fiber composite is “set/cured” in the desired profile by the application of heat to the resin/fiber composite.

More specifically, the fiber is drawn through a resin impregnator where the fiber is saturated with resin. The resin/fiber composite passes from the impregnator to a pre-former which forms the composite into the desired profile. The composite is then passed to a heating die where the resin is cured while the die maintains the composite in the desired profile. The cured product then exits the die and moves to the puller which applies a pulling force to the cured product, which pull passes through the reinforcing fibers back to the creels which feed the fiber materials to the process—thus the moniker “pultrusion”—which pulls product through the forming die and thus through the forming system, compared to “extrusion” which pushes softened e.g. polymeric material or metal through a forming die. On exiting the puller, the product can be cut to length, or otherwise converted to any desired length, width, or other desired form or shape.

For example, glass or other reinforcing fibers are impregnated with resin and pulled through a former and a heated die. The former orients the fibers according to the specified profile such that the fibers are properly positioned in the die, thus to ensure that the pultruded product has consistent reinforcement properties, as desired, across the profile of the pultruded structure. The resulting pultruded structure is continuously pulled from the heated die by the puller. The puller can be a clamp and stroke action from a reciprocating puller, or a consistently-pulling closed-track puller, also known as a caterpillar puller.

Reinforcing fibers used in pultrusions of the invention can be, for example and without limitation, glass fiber, carbon fiber, kevlar fiber, and/or other organic and inorganic filaments and fibers. Reinforcement fibers can take the forms of filament and strand bundles, called rovings. The fibers can also take the forms of yarns, texturized yarns, chopped strand mats, continuous strand mats, knitted mats, woven mats, surfacing veils, and combinations of rovings, yarns, mats, and veils, for example a combination of uniformly spaced fiberglass reinforcement fibers and continuous filament rovings.

Resins used in pultrusions of the invention can be thermosetting resins such as, without limitation, polyesters e.g. in a styrene solution, or polyurethanes, phenolics, epoxides, thermosetting mixtures and other thermosetting resins. Other resins used in pultrusion can be thermoplastic resins such as polyurethanes, acrylics, polyethylenes, and other thermoplastic resins. Resin used in pultrusion can also be thermoplastic resins which are embedded in solid/plastic state in fiber structures which are fed into the pultrusion process, and wherein the resins melt and/or otherwise deform inside the pultrusion die.

Resin mixtures in pultrusion can also contain organic, polymeric, and/or inorganic additives provided to achieve certain property modifications such as shrink control or limitation, mold lubrication, coloring, filling, and other specified property features.

Pultruded e.g. fiberglass-reinforced thermoset polyester has a longitudinal modulus of about 65,000 psi and a transverse modulus of about 10,000 psi. Thermal conductivity is 4.5 btu/ft²/hr/° F./inch thickness.

Pultruded cladding structures of the invention are sturdy and durable, and have favorable strength and rigidity, and favorable expansion and contraction ratings compared to alternative materials. The pultruded cladding structures tolerate a wide range of temperatures such as are encountered in constructed buildings. The pultruded cladding structures are not susceptible to water damage. Such cladding structures are less susceptible than e.g. aluminum to corroding under weather conditions to which they are exposed. Pultruded cladding structures exhibit desired thermal properties. Cladding kits of the invention are easily transported to the construction site. The cladding kits and cladded frames can be mass-produced and do not have to be project-specific, but custom sizes can easily be made.

Any given pultrusion can have a range of thicknesses of the respective walls of its profile. Such range of thicknesses can be related to the expedients of the pultrusion die, specific strength parameters desired for a certain portion of the profile, wall intersections, and the like. However, most pultruded structures of the invention used in cladding jambs and corresponding door frames have a generally consistent nominal profile thickness over most of the pultruded structure. The general thickness “T” (FIG. 3) of a wall of the pultrusion also varies according to the specific use which will be made of the specific pultrusion.

Where the pultruded cladding is supported by a substrate, the pultruded cladding can be relatively thinner, having a nominal thickness “T” of e.g. 0.050 inch to 0.075 inch, more commonly 0.060 inch to 0.065 inch, with a target thickness of about 0.062 inch. The here-recited thicknesses apply to common-size building entrance door frames such as residential door frames and garage door frames, as well as truck dock door frames. For example, residential garage door frames are typically 7 feet wide to 8 feet wide for a single garage door, and 15-18 feet wide for a double garage door. Exterior entry e.g. personnel doors on a building are typically 36 inches wide to 42 inches wide. Double entry doors are sometimes used, whereby the entry door frame is even wider.

Although the invention has been described with respect to various embodiments, it should be realized this invention is also capable of a wide variety of further and other embodiments within the spirit and scope of the appended claims. For example, either of the jamb plate or the nosing may be a non-pultruded material while the other is the pultruded structure. However, typically both the jamb plate and the nosing are pultruded structures.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. In combination, an elongate fiber-reinforced pultruded polymeric nosing, and an elongate fiber-reinforced pultruded polymeric jamb plate, collectively adapted to be mounted to each other and to a jamb substrate to define at least a portion of a building entrance door frame, such building entrance door frame at least in part defining a building entrance door opening,
(a) said elongate pultruded jamb plate having a first length, said elongate pultruded jamb plate comprising a main side panel, and an outer panel extending in a direction which defines an angle transverse to said main side panel and extending away from said main side panel to a distal end; and
(b) said elongate pultruded nosing being designed and configured to extend along a substantial portion of the length of said elongate jamb plate,
said pultruded jamb plate and said pultruded nosing collectively comprising mounting structure whereby said pultruded jamb plate and said pultruded nosing are adapted and configured to be mounted to each other through said mounting structure, which mounting structure communicates with said outer panel of said jamb plate, such that said nosing overlies at least a portion of said outer panel,
and wherein said pultruded jamb plate and said pultruded nosing can be assembled to each other and to such substrate to define at least a portion of such door frame, and such door frame at least in part defines such door opening in such building, and wherein the distal side of said nosing faces away from such door opening.

2. A combination as in claim 1, said elongate pultruded nosing having a proximal side and a distal side (58), said pultruded nosing extending from the proximal side to the distal side as a single-piece unitary structure, said pultruded nosing, when so mounted to said jamb plate, extending in a direction away from said main side panel of said jamb plate and along the outer surface of such substrate, to the distal side of said nosing, said nosing extending beyond the distal end of said outer panel, such that the distal end of the outer panel is disposed between said main side panel and the distal side of said nosing,
a mounting fin kerf being defined in one of said jamb plate and said nosing, in a region which extends from proximate the distal side of said nosing to the distal end of said outer panel.

3. A combination as in claim 2, said nosing and said jamb plate being mounted to each other, further comprising a mounting fin, as a separate and distinct element, in said mounting fin kerf, said mounting fin extending beyond the distal side of said nosing.

4. A combination as in claim 2, said mounting fin being deflectable, from a mounting position extending generally parallel to said outer panel and into proximity with such jamb substrate when said jamb plate is mounted to such jamb substrate.

5. A jamb cover assembly combination comprising a combination of a pultruded jamb plate and a pultruded nosing as in claim 1, said elongate pultruded jamb plate and said elongate pultruded nosing being finished to fit a first door size, said pultruded jamb plate and said pultruded nosing being collectively adapted and configured to be assembled into a jamb cover assembly which fits such first door size,
said elongate pultruded jamb plate having a first length, and comprising a 2-panel jamb plate,
said elongate pultruded nosing being designed and configured to extend along a substantial portion of such first length of said jamb plate and consisting of a single unitary structure,
said elongate pultruded jamb plate and said elongate pultruded nosing being mounted to each other, at least a portion of said mounting structure communicating with said outer panel of said pultruded jamb plate,
further comprising,
a mounting fin kerf in said elongate pultruded nosing, said mounting fin kerf, when said elongate pultruded nosing is mounted to said jamb plate at said outer panel, being located outwardly of the distal end of said outer panel, such that the distal end of said outer panel is disposed generally between said mounting fin kerf and said main side panel, said mounting fin kerf defining an opening configured to receive a mounting fin thereinto.

6. A jamb cover assembly combination as in claim 5, said mounting fin kerf being disposed at a distal side of said elongate pultruded nosing, further comprising a mounting fin, said mounting fin being designed and configured to be mounted in said mounting fin kerf.

7. A jamb cover assembly combination as in claim 5, said elongate pultruded nosing having a proximal side and extending, as a single-piece structure, from the proximal side to a distal side of said pultruded nosing, and wherein said pultruded nosing comprises a brick mold nosing which is defined, along the second length, by a generally constant cross-section.

8. A jamb cover assembly combination as in claim 6, said elongate pultruded nosing having a proximal side and extending, as a single-piece structure, from the proximal side to a distal side of said elongate pultruded nosing, and wherein said pultruded nosing comprises a brick mold nosing which is defined, along the second length, by a unitary cross-section.

9. A door frame having a left frame element, a right frame element, and a top frame element, said left frame element, said right frame element, and said top frame element being assembled from a jamb cover assembly combination as in claim 5.

10. A jamb cover assembly combination as in claim 5 wherein said mounting fin, when assembled to said elongate pultruded nosing, extends outwardly, away from such main side panel of said elongate pultruded jamb plate, in a direction comprising substantially an extension of such outer panel of such jamb plate, and beyond the distal end of such outer panel.

11. A jamb cover assembly combination comprising a combination of an elongate pultruded jamb plate and an elongate pultruded nosing as in claim 1, said elongate pultruded jamb plate, when finished to a first length, and said elongate pultruded nosing, when finished to a second length which cooperates with the first length, being collectively adapted and configured to be assembled into a jamb cover assembly, such jamb cover assembly being adapted and configured to define at least a portion of a door frame, such door frame at least in part defining a door opening through such door frame,
said elongate pultruded jamb plate and said elongate pultruded nosing being adapted and configured to be mounted to each other through such mounting structure such that said elongate pultruded nosing does not overlie said main side panel,
said elongate pultruded nosing having a proximal side, and extending as a single unitary structure from the proximal side to a distal side (58) of said elongate pultruded nosing, and wherein, when said elongate pultruded jamb plate and said elongate pultruded nosing are assembled to each other and at least in part define a portion of such door frame, and such door frame at least in part defines a portion of such door opening in such door frame, the distal side of said pultruded nosing faces away from such door opening and is disposed beyond the distal end of said outer panel of said jamb plate, such that the distal end of said outer panel is disposed between the distal side of said elongate pultruded nosing and said main side panel of said elongate pultruded jamb plate.

12. A combination as in claim 11, further comprising a mounting fin kerf in said elongate pultruded nosing, and a mounting fin adapted and configured to be mounted in said mounting fin kerf, wherein said mounting fin is designed and configured, and said mounting fin kerf is so located, that, when said mounting fin is mounted in said mounting fin kerf, and said pultruded nosing and said pultruded jamb plate are mounted to each other, and when said pultruded jamb plate is mounted to a jamb substrate, said mounting fin is capable of being articulated toward said main side panel and into proximity with such jamb substrate.

13. A combination as in claim 11 wherein said nosing and said jamb plate comprise fiberglass reinforced pultruded polymeric structures.

14. A door frame comprising a left frame element, a right frame element, and a top frame element, said left frame element, said right frame element, and said top frame element being assembled from combinations as in claim 11.

15. A combination as in claim 1, said pultruded jamb plate and said pultruded nosing being finished to fit a first door size, further comprising an elongate mounting fin finished to fit such first door size, said elongate pultruded jamb plate being adapted and configured to be mounted on a such jamb substrate of a such building entrance door frame of such first door size,
said elongate pultruded jamb plate further comprising first said mounting structure comprising first and second locks, said first and second locks being connected to said outer panel, and extending away from said outer panel, in a common direction,
said elongate pultruded nosing comprising said second mounting structure, designed and configured to cooperatively mount to said first mounting structure, thereby to mount said nosing to said jamb plate, said nosing, when mounted to said jamb plate, extending away from said main side panel,
said finished mounting fin being adapted to be mounted to said nosing to thereby form a nosing assembly, said finished mounting fin, when mounted to said finished nosing, and interfacing with such building in a mounting position to mount said mounting fin thereto, extending generally parallel to said outer panel, said mounting fin being deflectable, from such mounting position toward said main side panel of said jamb plate by about 90 degrees or more.

16. A combination as in claim 15, said nosing having a proximal side and extending, as a single-piece unitary structure, from the proximal side to a distal side (58) of said elongate nosing.

17. A jamb cover assembly combination comprising a combination of an elongate pultruded jamb plate and an elongate pultruded nosing as in claim 1, said elongate pultruded jamb plate being finished to a first door size so as to be adapted and configured to interface with such doorway substrate, said outer panel extending from a locus of joinder with said main side panel, said elongate pultruded jamb plate comprising first said mounting structure extending from said outer panel, said elongate pultruded nosing comprising a front panel (56), and second said mounting structure, comprising at least first and second legs, said elongate pultruded nosing, being adapted to mount, by said second mounting structure, to said pultruded jamb plate, said outer panel of said jamb plate, when said pultruded jamb plate is mounted in a doorway rough opening in such building, being disposed between at least one of said legs and such substrate, and as a separate and distinct element, a mounting fin adapted to be mounted to said elongate pultruded nosing, said mounting fin being deflectable, from a mounting position extending generally parallel to said outer panel, toward such substrate by about 90 degrees or more.

18. A jamb cover assembly combination as in claim 17, said elongate nosing having a proximal side and extending, as a single-piece unitary structure to a distal side (58) of said elongate nosing.

19. A jamb cover assembly combination comprising a combination of an elongate pultruded jamb plate and an elongate pultruded nosing as in claim 1, said elongate jamb plate being finished to fit a first door size, said elongate pultruded nosing being finished to fit such first door size, further comprising an elongate mounting fin finished to fit such first door size, said elongate pultruded jamb plate, said nosing, and said elongate mounting fin collectively being adapted and configured to be assembled into a jamb cover assembly, such jamb cover assembly being adapted and configured to be mounted to such substrate to thereby define a door frame member, a plurality of such door frame members being adapted and configured to, at least in part, define a door frame, such door frame, at least in part, generally defining such building entrance door opening, such door frame being adapted to be mounted in an entrance doorway rough opening in such building, such door frame generally having a main surface facing across such door opening, and a first outer surface facing away from such building,
said outer panel of said elongate pultruded jamb plate extending from a locus of joinder with said main side panel to the distal end, said elongate pultruded jamb plate further comprising first said mounting structure, comprising first and second locks on said outer panel, said first and second locks being proximate a common face of such substrate,
said nosing comprising second said mounting structure, adapted to cooperatively mount to said first mounting structure, thereby to mount said nosing to said jamb plate, and
said mounting fin being adapted to be mounted to said nosing, said mounting fin, when mounted to said nosing, being deflectable toward said main side panel of said jamb plate by about 90 degrees or more.

20. A jamb assembly, defining a door frame, which door frame generally defines a door opening in said door frame, said door frame being adapted and configured to be mounted in a doorway rough opening in a building, said jamb assembly generally having a main surface facing across such frame door opening, and a first outer surface facing away from such building, said jamb assembly comprising a combination as in claim 1, said outer panel of said jamb plate extending from a locus of joinder with said main side panel, and first said mounting structure on said jamb plate comprising first and second locks on said outer panel, said first and second locks being approximately equidistant from such jamb substrate, said pultruded nosing comprising second said mounting structure, cooperatively mounting to said first mounting structure, thereby mounting said pultruded nosing to said jamb, said jamb assembly further comprising, as a separate and distinct element, an elongate mounting fin mounted to said pultruded nosing, said elongate mounting fin being deflectable toward said main side panel of said jamb plate by about 90 degrees or more.

21. A jamb assembly as in claim 20, said elongate pultruded nosing and said mounting fin, in combination, defining an elongate nosing assembly, extending along a length of said jamb, said elongate nosing assembly being a 2-component nosing assembly.

22. A combination as in claim 1 wherein said elongate pultruded nosing does not overlie said main side panel, and wherein said elongate pultruded nosing has a proximal side, and extends as a single unitary structure from the proximal side to a distal side (58) of said elongate pultruded nosing, and wherein the distal side of said elongate pultruded nosing is disposed beyond the distal end of said outer panel of said jamb plate, such that the distal end of said outer panel is disposed between the distal side of said nosing and said main side panel of said jamb plate.

23. A combination as in claim 22, further comprising a mounting fin, said mounting fin and said elongate pultruded nosing being collectively adapted and configured to enable assembling said mounting fin and said elongate pultruded nosing to each other, and wherein said mounting fin is designed and configured such that said mounting fin is capable of being articulated toward said main side panel.

24. A door frame comprising a left frame element, a right frame element, and a top frame element, said left frame element, said right frame element, and said top frame element being assembled from combinations as in claim 1.

25. A door frame assembly combination which, when assembled into a door frame assembly, defines at least a portion of a door frame which defines a door opening through such door frame, such door frame being adapted and configured to be assembled to a building at an entrance opening to such building, said door frame assembly combination comprising a combination of an elongate fiber reinforced pultruded polymeric jamb plate and an elongate fiber reinforced pultruded polymeric nosing as in claim 1, and an elongate jamb substrate having a second length, the first length of said elongate pultruded jamb plate generally corresponding to the second length of said jamb substrate, said elongate pultruded nosing having a third length generally corresponding to the first length, said elongate pultruded nosing being joined to said elongate pultruded jamb plate,
said elongate pultruded jamb plate and said elongate jamb substrate defining an elongate frame element subassembly, said frame element subassembly having
(a) a first side defined by said pultruded jamb plate and facing across the door opening,
(b) a second side defined by said jamb plate and facing in a direction away from the door opening and away from such building when said door frame assembly combination is assembled to such building,
(c) a third side facing in an opposite direction from the first side, and
(d) a fourth side facing in an opposite direction from the second side,
said elongate pultruded nosing having a proximal side, and extending as a single unitary structure from the proximal side to a distal side of said elongate pultruded nosing,
said elongate frame element subassembly and said elongate pultruded nosing being mounted to each other through said mounting structure which communicates with only one of the second and fourth sides of said frame element subassembly.

26. A door frame assembly as in claim 25, further comprising a mounting fin kerf in said elongate pultruded nosing, located outwardly of the third side of said frame element subassembly, such that the third side of said frame element subassembly is disposed generally between said mounting fin kerf and the first side of said frame element subassembly.

27. A door frame assembly as in claim 25 wherein said elongate jamb plate and said elongate nosing comprise fiberglass reinforced pultruded structures.

28. A frame assembly combination, adapted and configured to be assembled into a frame assembly, said frame assembly combination comprising an elongate first frame member finished to fit a first size doorway and an elongate fiber reinforced pultruded polymeric nosing finished to fit such first size doorway,
said first frame member consisting of a single unitary structure, said first frame member having
(a) a main side panel on a first side of said first frame member, and
(b) an outer panel on a second side of said first frame member, and extending from a locus of joinder with said main side panel, at an angle transverse to said main side panel, to a distal end of said outer panel,
said elongate pultruded nosing having a proximal side and extending, as a single-piece unitary structure from the proximal side to a distal side (58) of said elongate pultruded nosing, such elongate pultruded nosing, when finished to fit such first doorway size, extending along a substantial portion of a first length of said first frame member, said first frame member and said pultruded nosing collectively comprising mounting structure whereby said first frame member and said pultruded nosing are adapted and configured to be mounted to each other through such mounting structure which communicates with said outer panel portion of said first frame member, thereby to assemble a frame assembly, a plurality of such frame assemblies being adapted and configured to be assembled into a door frame which fits such first doorway size, which door frame defines a doorway opening extending through such door frame,
further comprising,
a mounting fin kerf in said elongate pultruded nosing, said mounting fin kerf, when said finished first frame member and said finished elongate pultruded nosing are mounted to each other, being located outwardly of the distal end of said outer panel, such that the distal end of said outer panel is disposed generally between said mounting fin kerf and said main side panel.

29. A frame assembly combination as in claim 28, said mounting fin kerf defining an opening, the opening being configured to receive a mounting fin thereinto, further comprising a mounting fin in said mounting fin kerf, and wherein said mounting fin is adapted to be articulated toward the second side of said first frame member.

30. A frame assembly combination as in claim 28, said mounting fin kerf defining an opening, the opening being configured to receive a mounting fin thereinto, further comprising a mounting fin in said mounting fin kerf, said mounting fin being deflectable, from a mounting position extending generally parallel to said third side, toward said second side by about 90 degrees or more.

31. A frame assembly combination as in claim 28, said first frame member further comprising a third side, which third side faces away from such doorway opening and in a direction generally opposite the first side, said mounting fin kerf defining an opening, the opening being configured to receive a mounting fin thereinto, further comprising a mounting fin in said mounting fin kerf, said first frame member extending along a generally continuous path between the third side and the first side.

32. A door frame assembly comprising an elongate jamb having a first length and an elongate fiber reinforced pultruded polymeric nosing having a second length, and joined to said jamb,
said jamb having
(a) a main side panel, and
(b) an outer panel extending from a locus of joinder with said main side panel, at an angle transverse to said main side panel, to a distal end of said outer panel,
said elongate pultruded nosing having a proximal side and extending, as a single unitary structure, from the proximal side to a distal side (58) of said elongate pultruded nosing, said elongate pultruded nosing being mounted to said jamb,
further comprising
a mounting fin kerf in said elongate pultruded nosing, located outwardly of the distal end of said outer panel, such that the distal end of said outer panel is disposed generally between said mounting fin kerf and said main side panel, said mounting fin kerf defining an opening, configured to receive a mounting fin thereinto.

33. A door frame assembly as in claim 32, further comprising a mounting fin in said mounting fin kerf, said elongate pultruded nosing having a proximal side and extending, as a single piece unitary structure, from the proximal side to a distal side (58) of said elongate pultruded nosing, and wherein said pultruded nosing comprises a brick mold nosing which is defined, along the second length, by a generally constant cross-section.

34. A door frame assembly as in claim 33 wherein said mounting fin is adapted to be articulated toward said main side panel and into proximity with said jamb.

35. A door frame assembly having a left frame element, a right frame element, and a top frame element, each of said left frame element, said right frame element, and said top frame element comprising a jamb and an elongate pultruded nosing as in claim 32.

37. A frame assembly, defining at least a portion of a door frame, such door frame defining a door opening through such door frame, such door frame being adapted and configured to be assembled to a building at a doorway rough opening in such building, said frame assembly comprising an elongate frame element having a first length and an elongate fiber reinforced pultruded polymeric nosing having a second length, said elongate pultruded nosing being joined to said elongate frame element,
said elongate frame element having
(a) a first side adapted to face across such door opening,
(b) a second side adapted to face away from such door opening and away from such building, and extending from the first side, to a distal end of the second side,
(c) a third side facing away from such door opening, and in an opposite direction from the first side, and
(d) a fourth side facing away from such door opening and in an opposite direction from the second side,
said elongate pultruded nosing having a proximal side, and extending as a single unitary structure from the proximal side to a distal side of said elongate nosing,
said frame element and said pultruded nosing being mounted to each other through mounting structure which communicates with only one of the second and fourth sides of said frame element,
further comprising
a mounting fin kerf in said pultruded nosing, located outwardly of the distal end of the second side of said frame element, such that the distal end of the second side of said frame element is disposed generally between said mounting fin kerf and the first side of said frame element.

38. A frame assembly as in claim 37, further comprising a mounting fin mounted in said mounting fin kerf, and wherein said mounting fin is adapted to be articulated toward the second side of said frame element.

39. A frame assembly as in claim 37, further comprising a mounting fin mounted in said mounting fin kerf, said mounting fin being deflectable, from a mounting position extending generally parallel to said third side, toward said first side by about 90 degrees or more.

40. A frame assembly as in claim 37, further comprising a mounting fin mounted in said mounting fin kerf, said frame element consisting of a generally continuous unitary structure extending from the third side to the first side.

41. A door frame structure, adapted and configured to define at least a portion of a door frame, said door frame structure comprising an elongate jamb having a first length and an elongate fiber reinforced pultruded polymeric nosing having a second length, and joined to said jamb, said door frame structure, when in an assembly as at least a portion of a door frame, at least in part defining a door opening in said door frame,
said jamb comprising
(a) a main side panel, and
(b) an outer panel extending, from a locus of joinder with said main side panel, at an angle transverse to said main side panel, to a distal end of said outer panel,
said elongate pultruded nosing being designed and configured to extend along a substantial portion of such first length of said jamb,
said jamb and said pultruded nosing collectively comprising mounting structure whereby said jamb and said pultruded nosing are mounted to each other through such mounting structure which communicates with said outer panel of said jamb, and wherein said pultruded nosing overlies at least a portion of said outer panel and does not overlie said main side panel,
said elongate pultruded nosing having a proximal side and extending, as a single unitary structure, from the proximal side to a distal side (58) of said elongate pultruded nosing, said elongate pultruded nosing and said elongate jamb being mounted to each other and at least in part defining a portion of said door frame structure, the distal side of said elongate pultruded nosing facing away from the door opening in such door frame and being disposed beyond the distal end of said outer panel of said jamb, such that the distal end of said outer panel is disposed between the distal side of said elongate pultruded nosing and said main side panel of said elongate jamb.

42. A door frame structure as in claim 41, further comprising a mounting fin kerf in said elongate pultruded nosing, and a mounting fin mounted in said mounting fin kerf, wherein said mounting fin can be articulated toward said main side panel by at least 90 degrees or more.

43. A door frame, comprising a left frame element, a right frame element, and a top frame element, each comprising a door frame structure as in claim 42.

44. An elongate nosing assembly for mounting to an elongate jamb plate, wherein such elongate jamb plate is designed and configured to be mounted on an elongate jamb substrate of a door frame, wherein such elongate jamb plate comprises a main side panel, and at least one outer panel, such at least one outer panel being configured to extend at an angle transverse to such main side panel, and away from such main side panel, a given one such outer panel bearing a first mounting structure having first and second locks (48A, 48B), said elongate nosing assembly comprising
(a) an elongate fiber reinforced pultruded polymeric nosing comprising second mounting structure having third and fourth locks (54A, 54B), designed and configured to cooperatively mount to such first mounting structure of such jamb plate, thereby to mount said nosing to such jamb plate; and
(b) an elongate mounting fin mounted to said elongate pultruded nosing, and wherein said mounting fin is adapted to be articulated toward such main side panel of such jamb plate, and into proximity with a such jamb substrate when said elongate nosing assembly is mounted to a such jamb plate which is mounted to a such jamb substrate,
said elongate nosing assembly being a two-component assembly comprising said elongate pultruded nosing, as a single-piece nosing, and said elongate mounting fin.

45. An elongate nosing assembly as in claim 44, said mounting fin comprising a polymeric mounting fin, said elongate nosing assembly being a two-component assembly comprising said elongate pultruded nosing and said polymeric mounting fin.

46. An elongate nosing as in claim 44 wherein said elongate pultruded nosing comprises a fiberglass reinforced pultruded structure having nominal profile thicknesses of about 0.06 inch.

47. A nosing assembly as in claim 44 wherein said elongate pultruded nosing comprises a brickmold nosing.

48. A nosing assembly as in claim 44 wherein said elongate pultruded nosing extends outwardly, away from said main side panel, in a direction comprising substantially an extension of said outer panel, and beyond the distal edge of said outer panel.

49. An elongate nosing assembly as in claim 44, said second mounting structure being defined by first and second legs extending in a common direction toward such first mounting structure.

50. An elongate nosing assembly as in claim 44, said nosing comprising a front panel (56), said second mounting structure (54A, 54B) being disposed between said front panel and such outer panel of such jamb plate.

51. A mullion cover assembly, comprising:
(a) a first elongate fiber reinforced pultruded polymeric jamb plate comprising a first main side panel, a first outer panel extending at an angle transverse to said first main side panel, said first outer panel comprising a first mounting structure which defines a first locking locus corresponding to a first lateral location along a first width of said first outer panel;
(b) as a separate and distinct element, a second elongate fiber reinforced pultruded polymeric jamb plate comprising a second main side panel, a second outer panel extending at an angle transverse to said second main side panel, said second outer panel comprising a second mounting structure which defines a second locking locus corresponding to a second lateral location along a second width of said second outer panel, said first and second outer panels, when said first and second elongate jamb plates are mounted to first and second side surfaces of a mullion substrate, generally residing in a common plane with respect to each other; and
(c) an elongate fiber reinforced pultruded polymeric nosing comprising a third mounting structure which defines third and fourth locking loci corresponding to third and fourth lateral locations along a third width (W) of said elongate pultruded nosing,
said third and fourth locking loci on said elongate pultruded nosing being engageable with said first and second locking loci on said first and second elongate pultruded jamb plates thereby to mount said elongate pultruded nosing to said first and second elongate pultruded jamb plates such that said elongate pultruded nosing bridges said elongate pultruded jamb plates, and locks together the combination of said elongated pultruded nosing and said first and second elongated pultruded jamb plates, the distance between the third and fourth loci being at least as great as the sum of any extensions of said first and second outer panels, beyond said first and second locking loci, away from the respective said first and second main side panels.

52. A mullion cover assembly as in claim 51, said elongate pultruded nosing comprising a front panel spaced from said outer panels of said first and second elongate pultruded jamb plates.

53. A mullion cover assembly as in claim 51 wherein said jamb plates and said nosing comprise fiberglass reinforced pultruded structures.

54. A mullion cover assembly as in claim 53 wherein said pultruded structures have nominal profile thicknesses of about 0.06 inch to about 0.075 inch.

55. A mullion cover assembly as in claim 51 wherein said first and second outer panels are spaced from each other when said mullion cover assembly is mounted on a mullion substrate, with said elongate pultruded nosing snap-locked to said first and second elongate pultruded jamb plates, thereby to leave a portion of an outer surface of such mullion substrate uncovered, as an uncovered space between said first and second outer panels, and wherein said elongate pultruded nosing bridges such uncovered space thereby to complete the coverage of such outer surface of such mullion substrate.

56. A mullion cover assembly, comprising:
(a) a mullion substrate having a length, first and second opposing side surfaces facing in opposing directions, generally along an outer surface of a building when said mullion assembly is installed on such building, and an outer surface facing outwardly away from such outer surface of such building when said mullion assembly is installed on such building;
(b) an elongate fiber reinforced pultruded polymeric mullion substrate cover comprising a first side panel extending along at least a portion of the first side surface of said mullion substrate, a second side panel extending along at least a portion of the second side surface of said mullion substrate, said elongate pultruded mullion substrate cover further comprising an outer panel extending at angles transverse to said first and second main side panels, said outer panel facing away from such building and comprising first and second mounting structures;
(c) an elongate fiber reinforced pultruded polymeric nosing comprising third mounting structure engaged with said first and second mounting structures on said outer panel of said substrate cover and thereby mounting said nosing to said substrate cover at said outer panel.

57. A jamb cover assembly comprising an elongate fiber reinforced pultruded polymeric jamb plate having a first length and an elongate fiber reinforced pultruded polymeric nosing having a second length, and joined to said pultruded jamb plate, said pultruded jamb plate comprising a two-panel jamb plate having
(a) a main side panel, and
(b) an outer panel extending from a locus of joinder with said main side panel, at an angle transverse to said main side panel, to a distal end of said outer panel,
said elongate pultruded nosing extending in a straight line path along a substantial portion of the first length of said pultruded jamb plate and consisting of a single unitary structure,
said pultruded jamb plate and said pultruded nosing collectively comprising mounting structure whereby said pultruded jamb plate and said pultruded nosing are mounted to each other through mounting structure communicating with said outer panel of said pultruded jamb plate,
further comprising a mounting fin kerf in said pultruded nosing, located outwardly of the distal edge of said outer panel, such that the distal end of said outer panel is disposed generally between said mounting fin kerf and said main side panel, said mounting fin kerf defining an opening, facing away from said outer panel, and configured to receive a mounting fin thereinto.

58. A jamb cover assembly as in claim 57, further comprising a mounting fin in said mounting fin kerf.

59. A jamb cover assembly as in claim 57 wherein said elongate pultruded nosing comprises a brick mold nosing which is defined, along the second length, by a unitary cross-section profile.

60. A jamb cover assembly as in claim 58 wherein said elongate pultruded nosing comprises a brick mold nosing which is defined, along the second length, by a unitary cross-section profile.

61. A jamb cover assembly as in claim 58 wherein said mounting fin is adapted to be articulated toward said main side panel and into proximity with a jamb substrate.

62. A door frame having a left frame element, a right frame element, and a top frame element, each of said left frame element, said right frame element, and said top frame element comprising a jamb cover assembly as in claim 57.

63. A method of up-grading an existing door frame which defines a door opening through such door frame, such existing door frame comprising a door jamb having a main jamb surface which faces into the door opening, a first outer jamb surface which faces a first direction away from the door opening, and a second outer jamb surface which faces a second opposing direction away from the door opening, the method comprising installing fiber reinforced pultruded cladding elements over the main jamb surface and one of the outer jamb surfaces, the fiber reinforced pultruded cladding elements which are installed on a given such jamb comprising an elongate fiber reinforced pultruded jamb plate having a first length, and an elongate fiber reinforced pultruded nosing
the jamb plate which is installed on a given such jamb having
(a) a main side panel, and
(b) an outer panel extending from a locus of joinder with the main side panel, at an angle transverse to the main side panel, to a distal end of the outer panel,
the pultruded elongate nosing, which is installed on the given jamb plate, comprising a single unitary structure,
the pultruded jamb plate and the pultruded nosing being mounted to each other through mounting structure which communicates with the outer panel of the pultruded jamb plate adjacent only one of the first and second outer jamb surfaces,
further comprising
a mounting fin kerf in the pultruded nosing, located outwardly of the distal edge of the outer panel, such that the distal edge of the outer panel is disposed generally between the mounting fin kerf and the main side panel.

64. A method as in claim 63, the elongate pultruded nosing comprising a front panel (56), mounting structure (54A, 54B) on the elongate pultruded nosing being disposed between the front panel of the nosing and the outer panel of the pultruded jamb plate.

65. In combination, an elongate nosing assembly, and an elongate fiber reinforced pultruded polymeric jamb plate,
(a) said elongate pultruded jamb plate comprising a main side panel, and an outer panel extending at an angle transverse to said main side panel, and away from said main side panel, and first mounting structure comprising first and second locks, said first and second locks being connected to and extending away from said outer panel in a common direction; and
(b) said elongate nosing assembly comprising
(i) an elongate fiber reinforced pultruded polymeric nosing, said pultruded nosing comprising second mounting structure, said second mounting structure being designed and configured to cooperatively mount to said first mounting structure, thereby to mount said elongate pultruded nosing to said elongate pultruded jamb plate, said pultruded nosing, when mounted to said pultruded jamb plate, extending away from said main side panel, and
(ii) as a separate and distinct element, a mounting fin adapted to be mounted to said elongate pultruded nosing, said mounting fin, when interfacing with a building to mount said mounting fin thereto, extending generally parallel to said outer panel, said mounting fin being deflectable, from a mounting position extending generally parallel to said outer panel, toward said main side panel of said elongate pultruded jamb plate by about 90 degrees or more,
said elongate nosing assembly being a two-component assembly comprising said elongate pultruded nosing, as a single-piece nosing, and said mounting fin.

66. A combination as in claim 65, said second mounting structure being defined by first and second legs extending in a common direction toward such first mounting structure.

67. A combination as in claim 65, said elongate pultruded nosing comprising a front panel (56), said second mounting structure (54A, 54B) being disposed between said front panel and said outer panel of said jamb plate.

68. An elongate nosing assembly for use as part of a door frame, wherein such door frame comprises a frame member, said frame member having a first side panel, and a second outer panel, such second outer panel being configured to extend at an angle transverse to such first side panel, and away from such first side panel, such outer panel bearing a first mounting structure having first and second locks (48A, 48B), said elongate nosing assembly comprising
(a) an elongate fiber reinforced pultruded polymeric nosing comprising second mounting structure having third and fourth locks (54A, 54B), designed and configured to cooperatively mount to such first mounting structure of such frame member, thereby to mount said elongate pultruded nosing to such frame member; and
(b) a mounting fin mounted to said pultruded nosing, and wherein said mounting fin is adapted to be articulated toward such first side panel of such frame member, and into proximity with a such frame member when said elongate nosing assembly is mounted to a such frame member,
said elongate pultruded nosing having a proximal side and extending, as a single-piece unitary structure from the proximal side to a distal side (58) of said elongate pultruded nosing.

69. An elongate nosing assembly as in claim 78 wherein said elongate nosing comprises a fiberglass reinforced pultruded polymeric structure having nominal profile thicknesses of about 0.06 inch to about 0.075 inch.

70. A nosing assembly as in claim 78 wherein said elongate pultruded nosing, when mounted to such frame member, extends outwardly, away from such first side panel, in a direction comprising substantially an extension of such second outer panel, and beyond such distal end of such second outer panel.
